(19) United States
(12) Patent Application Publication
(10) Pub. No.: US 2007/0254589 A1
(43) Pub. Date: Nov. 1, 2007

(54) Audio modulating system and method

(75) Inventors: Thomas C. Sloan, Santa Barbara, CA (US); Darrell Euben, Camarillo, CA (US)

Correspondence Address: KOPPEL, PATRICK & HEYBL, 555 ST. CHARLES DRIVE, SUITE 107, THOUSAND OAKS, CA, 91360, US

(73) Assignee: SLOANLED, INC.

(21) Appl. No.: 11/413,995

(22) Filed: Apr. 28, 2006

(51) Int. Cl. H04B 1/68

(52) U.S. Cl. 455/47

(57) ABSTRACT

A modulating signal system comprising a filter circuit for accepting a frequency spectrum signal and selecting a range of frequencies from the frequency spectrum signal. An amplitude compensation circuit that accepts the range of signal frequencies from the filter circuit and adjusts the amplitude of the range of signal frequencies to substantially match a predetermined amplitude level and to produce a signal amplitude that is substantially the same for different signal amplitudes from said filter circuit. A voltage detector circuit for accepting the adjusted signal frequencies from said compensation circuit and generating digital pulses. The digital pulses can be used to generate LED control signals for controlling the illumination of LEDs based at least partially on the digital pulses. A method for generating a lighting control signal from an audio signal comprising providing an audio frequency spectrum signal and filtering out signal frequencies above a predetermined frequency and allowing signals frequencies below the predetermined frequency to pass. Modifying the amplitude of the passed frequencies to substantially match a predetermined signal amplitude level. Converting the modified passed frequencies to a series of digital pulses.

### BACKGROUND OF THE INVENTION

1. Field of the Invention

This invention relates to the lighting of pools, spas, and the like, and more particularly to lighting systems using light emitting diodes (LEDs).

2. Description of the Related Art

Reservoirs of water such as pools and spas are commonly constructed with one or more underwater light sources for illuminating the water within the reservoir. The light sources are visually appealing and the illumination of the water allows for safe use of the pool or spa at night. Conventional lighting units are commonly mounted on the wall of the pool or spa, and comprise a watertight housing that contains an incandescent light source.

A number of variations to the conventional pool or spa light have been developed. See U.S. Pat. No. 4,617,615 to Eychaner, U.S. Pat. No. 5,122,936 to Guthrie, and U.S. Pat. No. 5,051,875 to Johnson. One disadvantage of the lights disclosed in these patents is that each uses an incandescent, fluorescent or quartz light source. The life of these light sources is relatively short which results in periodic maintenance to replace the failed light sources. The cost of additional light sources and the periodic maintenance can add additional costs and the maintenance can be difficult to accomplish because the lights are usually below the water surface.

Fiber optic lighting systems have been developed for spas by, among others, Coast Spas located in British Columbia, Canada. The system generally includes a remote light source and numerous optical fibers directed toward a number of holes in the spa wall. Each hole has a cap to hold one of the optical fibers so that the light emitting from the end of the fiber is directed through the cap and into the water within the spa. Each cap has a transparent lens that disperses or focuses the light from the fiber.

The fiber optic remote light source is prone to failure and can require regular maintenance. The light source generally comprises an incandescent bulb and a color wheel that is turned by a mechanical mechanism. The wheel has sections of different colors and the light from the bulb is directed through the wheel where it is changed to the particular color of the wheel section it passes through. The light then enters the optical fibers and is transmitted to the interior of the spa. As the wheel turns, the different sections having different colors pass in front of the light source, changing the color passing into the optical fibers. The incandescent bulb has a relatively short life and the mechanical components of the wheel can fail or require maintenance.

LEDs are becoming a more common light source for use in spa illumination. Light emitting diodes (LEDs) are solid-state devices that convert electric energy to light, and generally comprise an active layer of semiconductor material sandwiched between two oppositely doped semiconductor layers. When a bias is applied across the doped layers, holes and electrons are injected into the active layer where they recombine to generate light. Light is emitted omnidirectionally from the active layer and from all surfaces of the LED. Recent advances in LEDs have resulted in highly efficient light sources that surpass the efficiency of filament-based light sources, providing light with equal or greater brightness in relation to input power.

### SUMMARY OF THE INVENTION

Briefly, and in general terms, the invention is directed to systems and methods for generating lighting control signals from a frequency signal, such as an audio frequency spectrum signal. One embodiment of a modulating signal system according to the present invention comprises a filter circuit for accepting a frequency spectrum signal and selecting a range of frequencies from the frequency spectrum signal. The system further comprises an amplitude compensation circuit that accepts the range of signal frequencies from the filter circuit and adjusts the amplitude of the range of signal frequencies to substantially match a predetermined amplitude level and to produce signal amplitude that is substantially the same for different signal amplitudes from said filter circuit. A voltage detector circuit accepts the adjusted signal frequencies from said compensation circuit and generating digital pulses.

One embodiment of a lighting system according to the present invention comprises an apparatus generating an audio frequency spectrum signal, and a modulating system accepting the audio frequency signal and generating a series of digital pulses based on the audio frequency signal. A light emitting diode (LED) controller accepts the digital pulses and generating LED control signals for controlling the illumination of LEDs based at least partially on the digital pulses.

One embodiment of a system for illuminating a reservoir of water according to the present invention comprises a reservoir shell capable of holding water, with lighting devices mounted to the reservoir shell to illuminate the interior of the shell. A lighting controller is included for generating lighting control signals to control the illumination of the lighting devices. An audio system generates an audio frequency spectrum signal and a modulating system accepts the audio frequency signal and generating a series of digital pulses based on the audio frequency signal. The lighting controller accepts the digital pulses and generates LED control signals that control the illumination of the lighting devices based at least partially on the digital pulses.

One embodiment of a method for generating a lighting control signal according to the present invention comprises providing a frequency spectrum signal, and filtering out a certain range of the frequency spectrum signal and passing the remaining frequencies of said frequency spectrum signal. The method further comprises modifying the amplitude of the passed frequencies of the frequency spectrum signal and converting the modified frequency spectrum signal to digital pulses.

An embodiment of a method for generating a lighting control signal from an audio signal according to the present invention comprising, providing an audio frequency spectrum signal and allowing frequencies below a predetermined level to pass and filtering out frequencies above the predetermined level. The method further comprises modifying the amplitude of the passed frequencies to substantially match a predetermined signal amplitude level, and converting the modified passed frequencies to a series of digital pulses.

These and further features and advantages of the invention will be apparent to those skilled in the art from the following detailed description, taken together with the accompanying drawings:

### BRIEF DESCRIPTION OF THE DRAWINGS

FIG. 1 is a block diagram showing a modulator system according to the present invention with its input and output. devices;

FIG. 2 is a block diagram of one embodiment of a modulator system according to the present invention;

FIG. 3 is a schematic of the electronic components and interconnections of one embodiment of a modulator system according to the present invention;

FIG. 4 is a perspective view of one embodiment of a spa using one embodiment of a modulator system according to the present invention;

FIG. 5 shows one embodiment of a method for providing a modulated signal according to the present invention; and

FIG. 6 shows another embodiment of a method for providing a modulated signal according to the present invention.

### DETAILED DESCRIPTION OF THE INVENTION

The present invention provides a modulating signal system arranged to be used with lighting systems for illuminating the water within a pool, spa or other water reservoir, all of which will be referred to collectively as a “spa”. The modulating signal system accepts an input signal and creates a control signal that can vary the illumination characteristics of lighting devices. In one embodiment according to the present invention, the modulating system accepts an input in the audio frequency wavelength spectrum, such as from a stereo, and creates a control signal that changes the illumination characteristics of light emitting diodes (LED or LEDs) based on the input signal. The LEDs can emit light at one frequency, or can be arranged as red, green and blue (RGB) emitting LED units that can emit a wavelength combination of red, green and/or blue light.

The frequency spectrum or frequency spectrum signal refers to signals having components with different frequencies. For example, an audio frequency spectrum signal can have signal components at different frequencies, all of which are in the audio frequency range.

One embodiment of a modulating system according to the present invention accepts audio frequency spectrum signals and generates control signals in the form of digital pulses that can be used to control the output of LEDs. The input to the modulating system can be tuned to different frequency ranges of the audio spectrum signal for different lighting effects. The modulating system is generally insensitive to changes in magnitude of the audio frequency signal such that the digital signal output is substantially constant over a large range of input amplitudes. The input to the modulating system can either be the line or speaker signal, and on either right or left side of the speaker signals. The lighting system is relatively simple, cost effective and easy to use.

Lighting systems according to the present invention can also work alone or in combination with other lighting systems to control the LED illumination, and although the present invention is described below in relation to spa lighting, it is understood that the invention can be used in many different lighting applications beyond spa lighting.

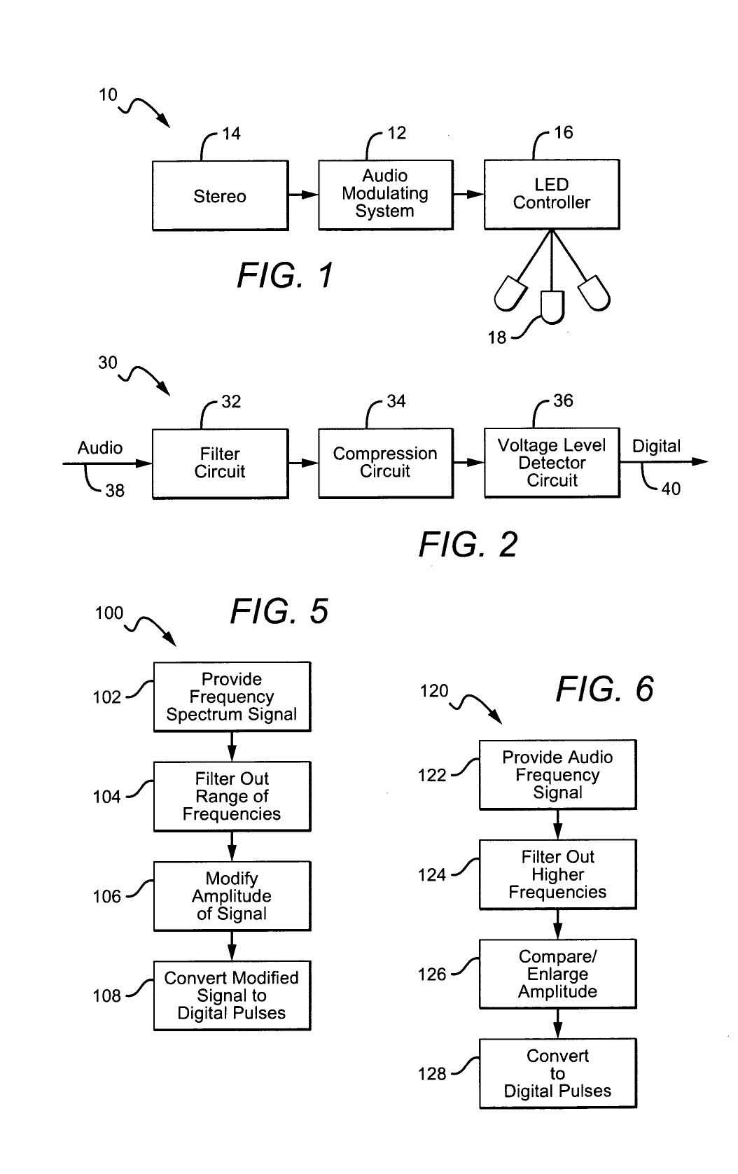

FIG. 1 shows one embodiment of a lighting system 10 according to the present invention having modulating system 12 that can accept an audio frequency signal and can generate digital control pulses. The modulating system is shown coupled to a stereo 14 at its input, although the modulating system 10 can be used with any other apparatus that provides a signal in the audio frequency wavelength spectrum. It is also understood that other embodiments of modulating systems according to the present invention can be arranged to accept frequencies in different wavelength spectrums from different apparatus.

In the system 10 the stereo's audio frequency signal can be coupled to the modulating system 12 along known signal conductors, such as conventional speaker wire, and can be connected to using known connectors. The audio frequency can be from either the stereo's line out, or right or left speaker output. The signal conductor preferably has a male RCA connector on its end that plugs into a female RCA jack on the modulating system 12 to complete the connection between the stereo 14 and modulating system 12. As more fully described below, the modulating system 12 can be tuned to produce modulating signals within a range of frequencies and is generally insensitive to changes in magnitude of the input signal.

The system 10 also comprises an LED controller 16 that controls the illumination of LEDs 18. In one embodiment, the LEDs can be arranged in the wall of a spa to illuminate the interior of the spa. The output of the modulating system 12 can plug into an LED controller 16 and the LED controller 16 can change the output characteristics of the LEDs 18 through hardware and/or software resident in the LED controller 16. In one embodiment, the LED controller 16 can be microprocessor based and can be programmed to function in different ways depending on its software program. The LED controller 16 can have hardware controls, such as buttons or dials, that can be manipulated by the spa user. In response to these manipulations the LED controller 16 can generate different control signals to the LEDs causing them to emit light in different ways. For example, each of the LEDs 18 can be an RGB unit that can emit a different color based on the control signals from the LED controller 16. The control signals can change depending on the position of the user buttons or controls. (light intensity). The LED controller can also have different operating modes that allow it to automatically generate control signals that cause the LED 18 to emit light in different color patterns or sequences. The LED controller 16 accepts the digital pulse signal from the modulating system 12 over a conventional conductor or wire, and based on that signal the software causes a change to the illumination of the LEDs 18. In a preferred embodiment, the software causes the light to strobe or modulate in response to the signal so that the modulating lights follow a certain frequency range of audio signal from the stereo.

FIG. 2 shows a block diagram of one embodiment of a modulating system 30 according to the present invention comprises three basic elements; filter circuit 32, amplitude compensation circuit 34 and voltage level detector circuit 36. The filter circuit 32 accepts the stereo audio signal along audio input 38 and is arranged to allow signal frequencies within a certain range to pass through. In a preferred embodiment the filter circuit 32 comprises a low pass filter that allows frequencies below a certain level to pass to the remainder of the system 30, and filters out frequencies above that level. The filter circuit 32 can allow different frequencies to pass, with a preferred circuit allowing frequencies below 500 Hz to pass. This allows the system to produce modulating signals to modulate the LEDs at a rate that can be visually perceived by the human eye. It is understood, however, that in other embodiments according to the present invention, other types of networks can be used such as high pass that allows signals above a certain frequency to pass, or a notch filter that allows signals within a certain frequency range to pass. In other embodiments, the frequency ranges can be adjustable to allow different frequencies to pass.

It is understood that a stereo audio signal can have different amplitudes based on among other factors, the volume setting for the system generating the audio signal. The amplitude compensation circuit 34 is arranged to make the modulating system 30 substantially insensitive to changes in magnitude of the stereo input signal. This allows the system 30 to operate and produce a digital signal through the full range of stereo input volumes. In particular, the amplitude compensation circuit 34 prevents the system from producing a modulating signal in saturation with high volume, i.e. staying on all the time. When the volume is low, this circuit 34 also allows the system 30 to continue producing a digital signal.

The voltage level detector 36 accepts the analog signal from the compressor circuit 34 and creates a digital pulse signal at its output 40. The digital signal can then be transmitted to the LEDs through another module or can be transmitted directly to the LEDs. As described above in lighting system 10, the digital signal can then be sent to an LED controller and based on the software in the controller, used to modulate the output of the LEDs.

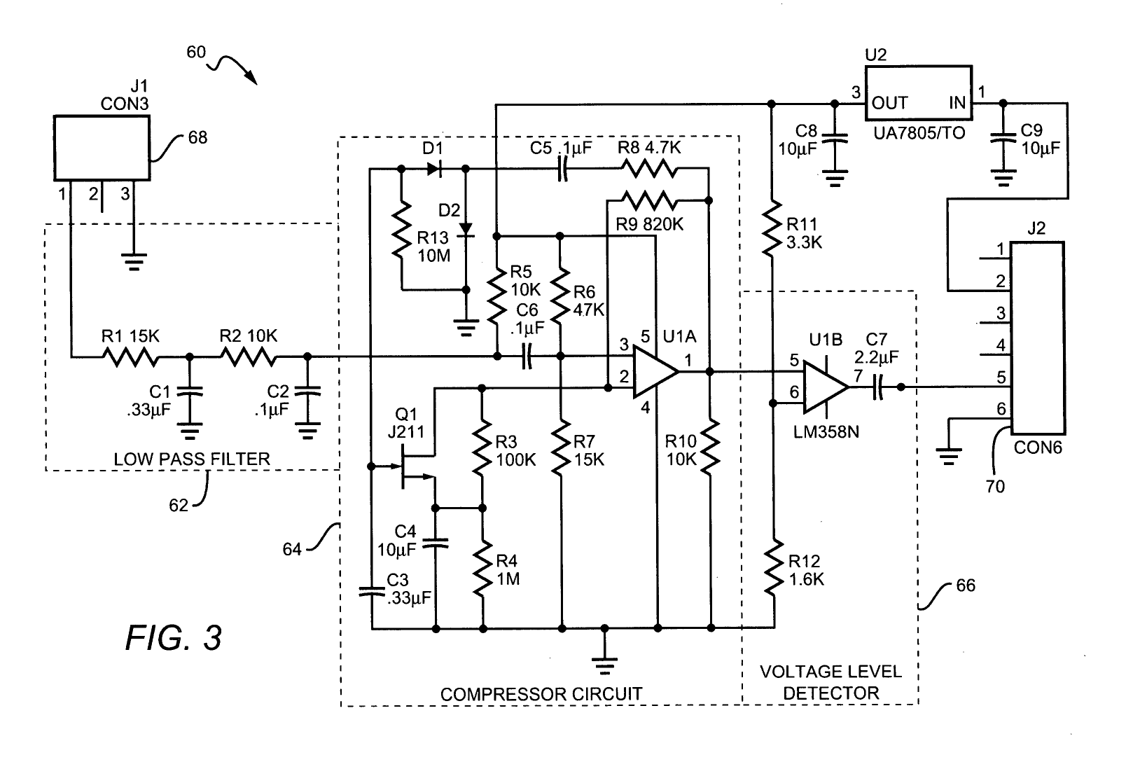

FIG. 3 shows a schematic of one embodiment of a modulating system 60 according to the present invention, and although certain components are shown it is understood that different embodiments of modulating systems according to the present invention can use many different components arranged in different ways. The phantom lines of the schematic show the filter circuit 62, amplitude compensation (compressor) circuit 64 and voltage level detector circuit 66.

The audio frequency signal is coupled to the system 60 at input connector 68 and transmitted to the filter circuit. The filter circuit 62 comprises a conventional network comprising resistors R1 and R2, and capacitors C1 and C2 all of which coupled together using in a way known to those skilled in the art. The RC network functions as a low-pass filter and allows frequencies below a certain level to pass. As mentioned above, however, in other embodiments the low pass filter can be a notch filter or a high pass filter. The frequencies are transmitted to the amplitude compensation circuit 64.

Amplitude compensation circuit 64 generally comprises a variable gain amplifier U1A arranged so that its gain can change with changes in the magnitude of the input signal (changes in volume). Many different commercially available operational amplifiers can be used, with a suitable operational amplifier being the LM358N Low Power Dual Operation Amplifier provided by National Semiconductor Corporation. The amplitude compensation circuit 64 also generally comprises a commercially available field effect transistor (FET) Q1 that is coupled to its surrounding components to change the feedback loop that in turn changes the gain of the operational amplifier U1A. The impedance of Q1 is changed depending on the output of the feedback loop through resistor R8 and capacitor CS. As the volume increases, the gain of the amplifier goes lower, making the overall output of the amplitude compensation circuit 64 relatively constant.

The voltage level detector circuit generally comprises an operational amplifier U1B that can also be different commercially available operational amplifiers such as a LM358N Low Power Dual Operation Amplifier provided by National Semiconductor Corporation. The operation amplifier is coupled to its surrounding components to convert the analog signal from the amplitude compensation circuit 64 to a series of digital pulses that are then transmitted to the output connector 70.

The embodiment of the modulating system 60 shown is arranged to get its power through output connector 70. In this arrangement the modulating system 60 is powered by the apparatus it connects to, such as the LED controller 16 shown in FIG. 1 and described above. This allows the modulating system 60 to operate without having its own power source or connection to the spa power supply, which simplifies the connections and complexity of the system 60. The power enters the system 60 and is coupled to a voltage regulator U2. Many different voltage regulators can be used, with a suitable one being the commercially available UA7800 Positive-Voltage Regulator provided by Texas Instruments Incorporated. The voltage regulator U2 is arranged to supply the desirable level of power to the system 60 that is substantially free of noise and distribution problems.

In the embodiment the output of the modulating system 60 is coupled to an LED controller having software that senses for the presence of digital pulses from the modulating system. If no audio signal is provided at the lighting system input (or the lighting system is off), the lighting system does not produce a digital signal at its output. The LED controller does not sense the presence of a digital signal and the LED controller's software does not change the output of the LEDs. (pulsing, color changing, etc.). In response to the digital pulses from the modulating system 60, the LED controller preferably causes the LEDs to modulate or strobe to match the low frequency component of the audio signal from the stereo. The modulating system 60 is flexible in that it can be used with or without a stereo input and can be used with any other systems producing signals in the audio frequency spectrum, such as a television, radio, iPod®, MP3 Player, etc.

The modulating system has other components, such as resisters and capacitors, that are known in the art and are coupled in the schematic in ways known in the art. For brevity, these components are not discussed herein, but those skilled in the art would understand the functioning of these components as shown.

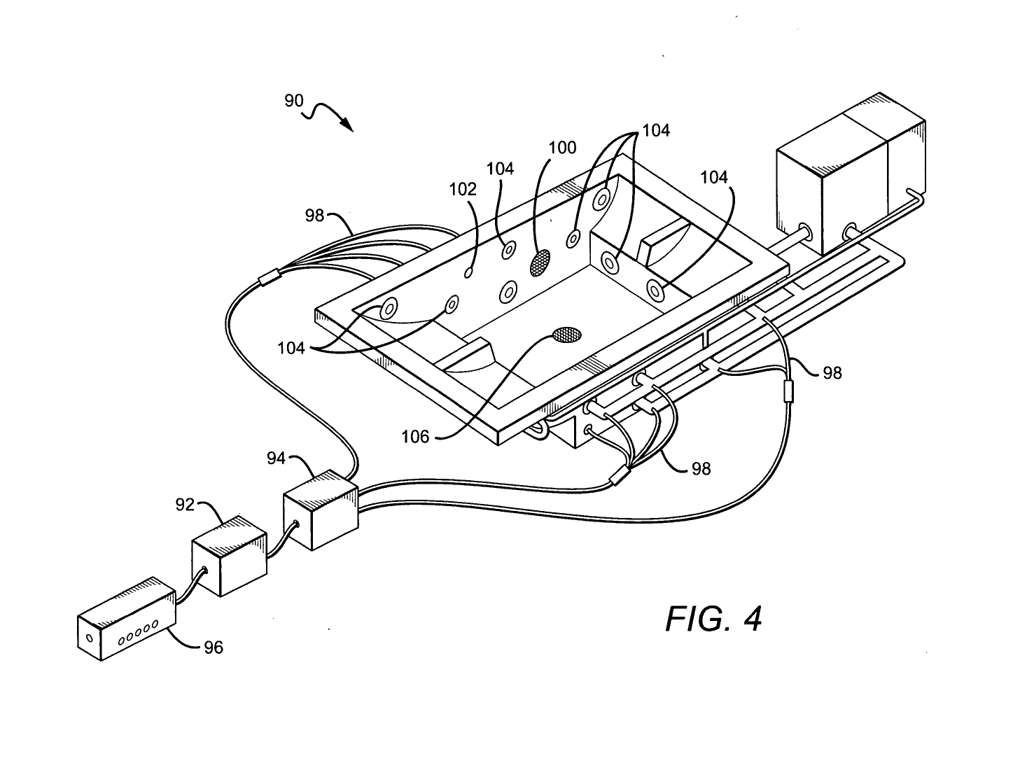

FIG. 4 shows one embodiment of a spa 90 that can utilize one or more modulating systems 92 according to the present invention, with the output of the modulating system 92 preferably coupled to an LED controller 94 that controls the illumination of the spa's LEDs. The LEDs preferably comprise RGB LED units 98 that, under control of the LED controller, each emits a wavelength combination of red, green and blue. The input of the modulating system 92 is preferably coupled to a source for an audio signal, such as a stereo 96. The RGB LED units 98 are typically arranged to illuminate the interior of the spa 90 through different spa components including spa flood lights 100, point lights 102, jets 104, drains 106, skimmers, etc. Each of the RGB LED units 98 can be held in place at its spa component by many different methods such as an adhesive, epoxy, clip, or cap. In response to the digital pulses from the modulating system 92, the LED controller 94 causes the output of the RGB LED units 98 to change, e.g. modulate or strobe, thereby causing the illumination of the interior of the spa to also change.

FIG. 5 shows one embodiment of a method 100 according to the present invention for generating a lighting control signal. In step 102 a frequency spectrum signal is provided, and in step 104 a certain range of frequencies is filtered out from the frequency spectrum signal. This range can comprise frequencies below a certain level (low pass), above a certain level (high pass), or within a certain frequency range (notch). In step 106, the amplitude of the passed frequency is modified so that different amplitudes of the passed signal have substantially the same amplitude after step 106. In step 108, the amplitude modified signal is converted from an analog signal to digital pulses. The digital pulses can then be used to directly control LEDs or to control LED through an LED controller.

FIG. 6 shows another embodiment of a method 120 according to the present invention for generating a lighting control signal. In step 122 an audio frequency spectrum signal is provided and in step 124 the higher frequency portion of the audio signal is filtered out. In step 126 the higher amplitude of the filtered signal are compressed and the lower amplitude of the filtered signal are enlarged. This allows for substantially similar amplitude signals to be provided and is preferably accomplished by using an operational amplifier having variable gain controlled by a feedback loop. In step 128, the compressed/enlarged converted to digital pulses used to control LED illumination.

Although the present invention has been described in considerable detail with reference to certain preferred configurations, other versions are possible. The invention can be used in spas, pools, tubs and the like. Different spa, pool or tub components can use the invention for water illumination. Therefore, the spirit and scope of the appended claims should not be limited to the preferred versions described above.

We claim:

1. A modulating signal system, comprising:
a filter circuit for accepting a frequency spectrum signal and selecting a range of frequencies from said frequency spectrum signal;
an amplitude compensation circuit that accepts said range of signal frequencies from said filter circuit and adjusts the amplitude of said range of signal frequencies to substantially match a predetermined amplitude level to produce a signal amplitude that is substantially the same for different signal amplitudes from said filter circuit; and
a voltage detector circuit for accepting the adjusted signal frequencies from said compensation circuit and generating digital pulses.

2. The modulating signal system of claim 1, wherein said frequency spectrum signal is an audio signal.

3. The modulating signal system of claim 2, wherein said audio signal is a stereo audio signal.

4. The modulating signal system of claim 1, wherein said filter circuit comprises low pass filter that selects a signal below a predetermined frequency.

5. The modulating signal system of claim 2, wherein said filter circuit comprises a resistor and capacitor (RC) circuit.

6. The modulating signal system of claim 1, wherein said filter circuit is a high pass filter or a notch filter.

7. The modulating signal system of claim 1, wherein said amplitude compensation system comprises a first operational amplifier having a feedback loop to change the gain of said operational amplifier depending on the amplitude of said range of signal frequencies.

8. The modulating signal system of claim 2, wherein said feedback loop comprises a field effect transistor (FET) coupled to said first operational amplifier and having an impedance that changes depending on the amplitude of said signal frequencies.

9. The modulating signal system of claim 1, wherein said voltage detector circuit comprises a second operational amplifier.

10. A lighting system, comprising:
an apparatus generating an audio frequency spectrum signal,
a modulating system accepting said audio frequency signal and generating a series of digital pulses based on said audio frequency signal; and
a light emitting diode (LED) controller accepting said digital pulses and generating LED control signals for controlling the illumination of LEDs based at least partially on said digital pulses.

11. The lighting system of claim 10, wherein said frequency spectrum signal is a stereo audio signal.

12. The lighting system of claim 10, wherein said modulating system comprises:
a filter circuit for selecting a range of frequencies from said frequency spectrum signal;
an amplitude compensation circuit that accepts said range of signal frequencies from said filter circuit and adjusts the amplitude of said range of signal frequencies to produce a signal amplitude that is substantially the same for different signal amplitudes from said filter circuit; and
a voltage detector circuit for accepting the adjusted signal frequencies from said compensation circuit and generating digital pulses.

13. The lighting system of claim 10, wherein said (LED) control signals comprise strobe or modulating control signals.

14. The lighting system of claim 10, wherein said modulating system is powered from said LED controller.

15. A system for illuminating a reservoir of water, comprising:
a reservoir shell capable of holding water;
lighting devices mounted to said reservoir shell to illuminate the interior of said shell;
a lighting controller for generating lighting control signals to control the illumination of said lighting devices;
an audio system for generating an audio frequency spectrum signal; and
a modulating system accepting said audio frequency signal and generating a series of digital pulses based on said audio frequency signal, said lighting controller accepting said digital pulses and generating LED control signals that control the illumination of said lighting devices based at least partially on said digital pulses.

16. The system of claim 14, wherein said audio system comprises a stereo.

17. The system of claim 15, wherein said modulating system comprises
a filter circuit for selecting a range of frequencies from said frequency spectrum signal;
an amplitude compensation circuit that accepts said range of signal frequencies from said filter circuit and adjusts the amplitude of said range of signal frequencies to produce a signal amplitude that is substantially the same for different signal amplitudes from said filter circuit; and
a voltage detector circuit for accepting the adjusted signal frequencies from said compensation circuit and generating digital pulses.

18. The system of claim 15, wherein said (LED) control signals comprise strobe or modulating control signals.

19. The system of claim 15, wherein said modulating system is powered from said LED controller.

20. A method for generating a lighting control signal, comprising:
providing a frequency spectrum signal;
filtering out a certain range of said frequency spectrum signal and passing the remaining frequencies of said frequency spectrum signal;
modifying the amplitude of said passed frequencies of said frequency spectrum signal;
convert said modified frequency spectrum signal to digital pulses.

21. A method for generating a lighting control signal from an audio signal, comprising:
providing an audio frequency spectrum signal;
filtering out frequencies above a predetermined frequency and allowing frequencies below said predetermined frequency to pass;
modifying the amplitude of said passed frequencies to substantially match a predetermined signal amplitude level;
converting said modified passed frequencies to a series of digital pulses.
